(19) United States
(12) Patent Application Publication
(10) Pub. No.: US 2023/0057182 A1
(43) Pub. Date: Feb. 23, 2023

(54) PRODUCED WATER TREATMENT WITH CO2 ABSORPTION

(71) Applicant: Austin J. Shields, Houston, TX (US)

(72) Inventor: Austin J. Shields, Houston, TX (US)

(21) Appl. No.: 17/820,086

(22) Filed: Aug. 16, 2022

Related U.S. Application Data
(60) Provisional application No. 63/234,443, filed on Aug. 18, 2021.

(51) Int. Cl. C02F 9/00; C25B 1/34; C25B 15/08; C01F 11/18; C01B 7/01; C01F 5/22; C01D 7/07

(52) U.S. Cl. CPC C02F 9/00; C25B 1/34; C25B 15/081; C25B 15/087; C01F 11/181; C01B 7/012; C01F 5/22; C01D 7/07; C02F 2209/06; C02F 1/66

(57) ABSTRACT

Disclosed herein is an improved method of brine water treatment including the removal of calcium and/or magnesium-based hardness utilizing CO₂ mineralization resulting in permanent sequestration of the CO₂ via stable precipitates in conjunction with hydrogen and chlorine production from the electrolysis of brine water.

### BACKGROUND

With the earth's climate change linked to increasing CO₂ levels in the atmosphere, alternative clean fuels such as hydrogen may be used to store and release energy instead of combusting fossil fuels. The combustion of hydrocarbons is widely attributed to the rise in atmospheric CO₂ levels. The world faces additional challenges with respect to a reduction in freshwater availability. Utilizing brines or produced water to economically produce products of value is an important objective to reduce the strain on the environment.

### Hydrogen Production

Hydrogen may be a viable alternative to fossil fuels as an energy source because it does not emit greenhouse gases when combusted or used to power fuel cell applications. However, traditional methods of hydrogen generation are power intensive and generally produce significant carbon emissions, defeating the goal of the process—reduced atmospheric emissions of CO₂. A common critique of hydrogen power is that it takes more energy to create hydrogen than the hydrogen releases when consumed. Currently available renewable hydrogen generation may be too expensive for widespread adoption, especially in areas where solar and wind power conditions are not optimal.

One method of hydrogen production is by electrolysis. Modern electrolysis of brine may consist of passing a brine with high sodium chloride content through an electrolysis cell. An electrolysis cell may have a cathode and an anode separated by a semi permeable membrane. In the anode side of the cell, concentrated brine enters, and a less concentrated brine exits after releasing chlorine gas. The sodium ions released from the electrolysis of brine migrate across the membrane via diffusion to react in the cathode reaction and become sodium hydroxide. In the cathode side of the cell, water enters, and a more basic pH water exits the cell in the form of an aqueous sodium hydroxide solution. Hydrogen gas is released in the cathode side of the cell. While water is abundant on the earth's surface, many water sources may require pre-treatment to be suitable for use in an electrolysis-based hydrogen production process.

### Produced Water

In oil and gas fields, it is common for multiple barrels of produced brine water to be produced along with every barrel of oil or thousand cubic feet of gas. Before the shale boom and rise of hydraulic fracturing, these volumes were relatively small on an absolute basis, both because there were not as many producing wells and because the producing wells tended to target oily zones with less water production. The advent of hydraulic fracturing changed operational procedures such that hundreds of thousands of barrels of water are pumped into the ground at the time of fracturing in each of the tens of thousands of horizontal wells drilled. Consequently, even more water is produced when the wells are brought online to recover the hydrocarbons. Produced water volumes are materially significant and finding a place to store of dispose of them can be problematic.

### Carbon Capture

Carbon capture has been the subject of much focus in recent years as the link between CO₂ emissions and global climate change has been investigated. A significant portion of CO₂ emissions come from power generation and industrial processes. Capturing and disposing of this CO₂ can be problematic.

### SUMMARY

An integrated process that can both produce industrial products of value from wastewater and eliminate the emissions from power generation used to drive said process is both novel and highly desirable. Such a process as described herein provides a method for low carbon or carbonless hydrogen production while simultaneously cleaning produced water of contaminants, making it suitable for use in electrolysis, or as a base water for agricultural, industrial, or residential use pending further treatment. Ion rich produced waters may be used to capture the carbon dioxide produced from fossil fuel combustion, permanently sequestering the carbon dioxide in stable, solid precipitate forms. The produced hydrogen may be used in its pure form to store energy or combined with chlorine and/or NaOH (the other products of electrolysis of brine) to yield industrial products of value with minimal or no carbon dioxide emissions. Utilizing a high brine content produced water as input water, then purifying that water for use in an electrolysis cell may economically produce the very base (NaOH) needed as a key ingredient in the purification process. This unique process may also produce multiple, desirable, product streams of value in challenging environments.

A method of water treatment can include obtaining produced water containing Ca²⁺ ions, combining the produced water with NaOH to increase a pH of the produced water, combining the produced water with byproducts of hydrocarbon combustion containing CO₂, thereby dissolving the CO₂ in the produced water and increasing a concentration of CO₃²⁻ that combines with the Ca²⁺ to produce CaCO₃, precipitating the CaCO₃ (thereby lowering the pH of the produced water) to produce a CaCO₃ product stream and an aqueous product stream, and providing at least a portion of the aqueous product stream to an electrolysis cell, wherein the electrolysis cell produces the NaOH that is combined with the produced water.

The produced water further can further contain Mg²⁺ ions that combine with the NaOH to produce Mg(OH)₂. The method can further include controlling the pH of the produced water to selectively precipitate the Ca²⁺ ions while precipitating relatively few Mg²⁺ ions.

The method can further include using at least a portion of the aqueous product stream for hydraulic fracturing of a hydrocarbon bearing formation.

The method can further include pretreating the portion of the aqueous product stream provided to the electrolysis cell using an ion exchange process that reduces trace ions other than Na⁺ and Cl⁻ in the aqueous product stream to produce an output stream having acceptable ion concentrations for operation of the electrolysis cell. Pretreating the portion of the aqueous product stream provided to the electrolysis cell can further include increasing a NaCl concentration of the output stream prior to providing it as an input stream to the electrolysis cell, thereby improving electrolysis cell efficiency. The method can further include providing a portion of the output stream not provided as an input stream to the electrolysis cell to a de-salinification process that produces NaCl and a reduced salinity water product. The method can further include adding NaCl produced by the de-salinification process to the output stream prior to providing it as an input stream to the electrolysis cell, thereby improving electrolysis cell efficiency.

The method can further include combining NaOH produced by the electrolysis cell with a portion of the CO₂ from the byproducts of hydrocarbon combustion to produce Na₂CO₃. The method can further include combining the Na₂CO₃ with the produced water to enhance production of CaCO₃.

The electrolysis cell can be powered by electricity produced by the energy from the hydrocarbon combustion. H₂ gas and Cl₂ gas produced by the electrolysis cell can be combined to produce HCl. NaOH and Cl₂ produced by the electrolysis cell can be provided as inputs to a NaClO reactor to produce NaClO.

The method can further include providing at least a portion of the aqueous product stream as an input into a Mg²⁺ precipitation process that further comprises adding NaOH to precipitate Mg(OH)₂ to produce a further aqueous product stream and providing at least a portion of the further aqueous product stream to the electrolysis cell. The method can further include pretreating the portion of the further aqueous product stream provided to the electrolysis cell using an ion exchange process that reduces trace ions other than Na⁺ and Cl⁻ in the aqueous product stream to produce an output stream having acceptable ion concentrations for operation of the electrolysis cell. Pretreating the portion of the aqueous product stream provided to the electrolysis cell further comprises increasing a NaCl concentration of the output stream prior to providing it as an input stream to the electrolysis cell, thereby improving electrolysis cell efficiency. The method can further include providing a portion of the output stream not provided as an input stream to the electrolysis cell to a de-salinification process that produces NaCl and a reduced salinity water product. The method can further include adding NaCl produced by the de-salinification process to the output stream prior to providing it as an input stream to the electrolysis cell, thereby improving electrolysis cell efficiency.

The method can further include combining NaOH produced by the electrolysis cell with a portion of the CO₂ from the byproducts of hydrocarbon combustion to produce Na₂CO₃. The method can further include combining the Na₂CO₃ with the produced water to enhance production of CaCO₃.

The electrolysis cell can be powered by electricity produced by the energy from the hydrocarbon combustion. H₂ gas and Cl₂ gas produced by the electrolysis cell can be combined to produce HCl. NaOH and Cl₂ produced by the electrolysis cell can be provided as inputs to a NaClO reactor to produce NaClO.

The produced water is selected from the group consisting of water produced from a hydrocarbon well and seawater.

### BRIEF DESCRIPTION OF THE DRAWINGS

FIG. 1 illustrates an exemplary electrolysis cell.

FIG. 2 illustrates the water life cycle of produced water from oil and gas production.

FIG. 3 illustrates the change in concentration of the various forms taken by dissolved CO₂ as a function of pH value.

FIG. 4 shows a list of key chemical reactions.

FIG. 5 illustrates an example of the input water requirements for a brine electrolysis cell.

FIG. 6 illustrates the Shields process—an integrated water treatment process that removes the Ca²⁺ and Mg²⁺ hardness from brine water using CO₂ emissions from fossil fuel combustion combined with sodium hydroxide produced via the electrolysis of brine.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

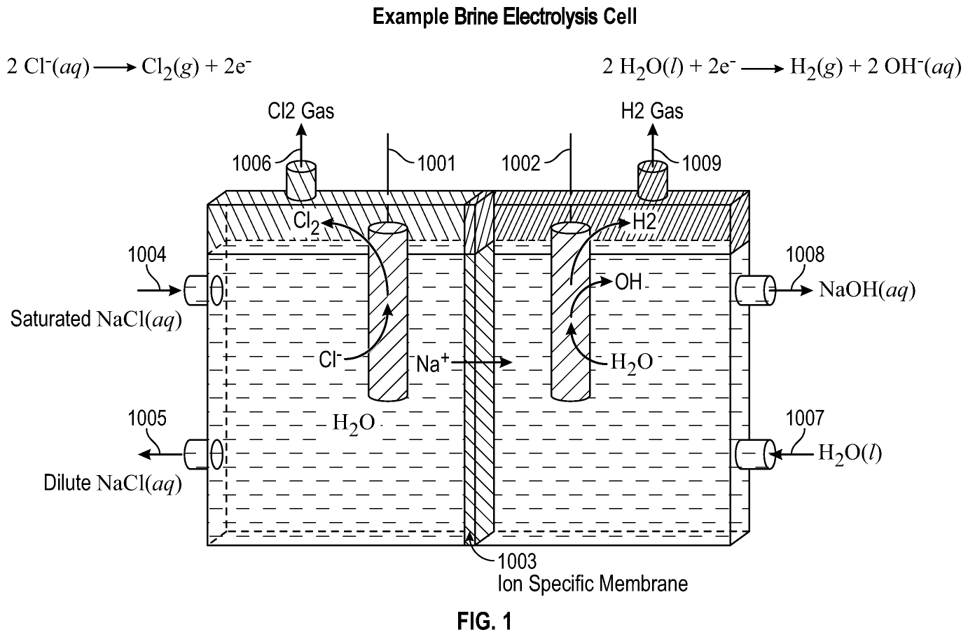

As noted above, electrolysis of brine may be used to produce hydrogen. A diagram of an exemplary electrolysis cell is shown in FIG. 1. A common cell arrangement involves two electrodes submersed in fluid—anode 1001 and cathode 1002. An electrical current can pass through the electrodes, which can be separated by an ion specific membrane 1003. Membrane 1003 may separate the anode and cathode and be ion selective to restrict the movement of target particles. On the anode side, concentrated brine 1004 enters and a less concentrated brine 1005 exits with chlorine gas (Cl₂) 1006 being liberated during the reaction. On the cathode side, water 1007 enters and leaves as aqueous sodium hydroxide (NaOH) 1008. Hydrogen gas (H₂) 1009 is liberated from the solution on the cathode side. Electrolysis anode, cathode, and membrane life is dependent on a clean, saturated brine lacking material concentrations of contaminants or hardness ions such as calcium (Ca²⁺) or magnesium (Mg²⁺).

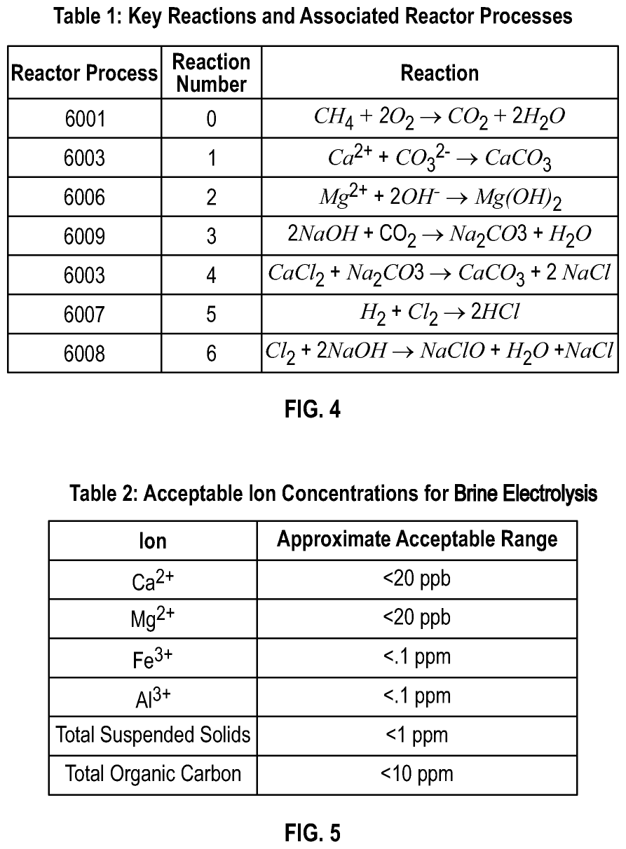

Hydrogen and chlorine may be combined to make hydrochloric acid via Reaction 5 (FIG. 4), or the chlorine may be reacted with the sodium hydroxide to yield sodium hypochlorite via Reaction 6 (FIG. 4), commonly referred to as bleach, leaving the hydrogen stream for other uses. In recent years, hydrogen has been a focus of attention due to its high energy density and use as a carbon free fuel. When hydrogen is split in a fuel cell, electricity can be generated to power a motor or other process with no carbon emissions released. The high energy density of hydrogen relative to battery storage has made it attractive as a transportation fuel substitute to gasoline and diesel. Reliable, low carbon hydrogen generation could drastically accelerate adoption as a fuel.

With any electrolysis process, the emissions of the process are linked to the emissions created by the electricity generation used to drive the electrolysis cell. For example, if a natural gas fired power plant supplies the electricity to drive the electrolysis cell, the emissions for the process will be linked to the efficiency and emissions of the natural gas combustion at the plant. Without carbon capture at the source of electricity generation, hydrogen cannot be produced via fossil fuel combustion without incurring significant carbon emissions.

The base water for brine electrolysis to produce hydrogen has traditionally been a fresh water that undergoes polishing reactions designed to remove small concentrations of undesirable ions. Salt may be added to the fresh water to create a concentrated brine. Increasing industrial demands for fresh water, such as the electrolysis process, may strain the amount of fresh water required for continued residential or agricultural use in certain geographies. The historical requirement for available fresh water may make the process expensive or environmentally undesirable in arid or desert environments.

Novel solutions are necessary to generate hydrogen without material, additional carbon emissions. Using a brine water with high total dissolved solids such as produced brines from hydrocarbon producing reservoirs is one such possible solution. In most oil and gas fields, the produced water that comes to surface with the oil is eventually injected back into the earth in saltwater disposal wells. As the underground pore space, or storage volume, of the disposal wells fills up, pressure increases to the point where it may fracture the rock integrity of the disposal zone and contaminate other zones, whether they be fresh water or hydrocarbon bearing zones. Injection of produced water from oil and gas reservoirs into disposal reservoirs is linked to increased tectonic activity, resulting in earthquakes from induced seismicity. To relieve the pressure in the disposal reservoir zones, thus reducing the likelihood of earthquakes, an economic, industrial scale use for the produced water associated with oil and gas would be highly beneficial. If water can be released from these disposal zones and used to power carbon free industrial processes, the environment and economic prospects of remote areas will both improve significantly.

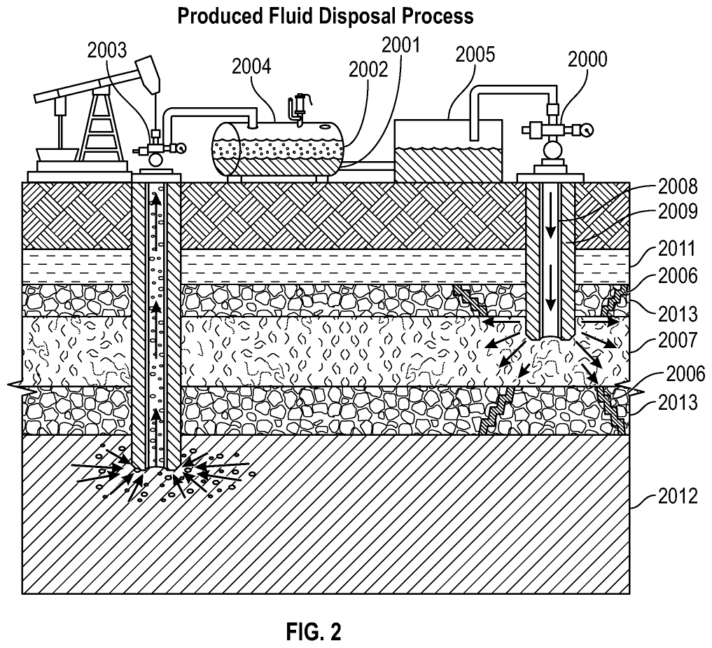

FIG. 2 illustrates the water life cycle of produced water from oil and gas production. An oil and gas well 2003 may produce both oil 2002 and produced water 2001 that can be sent to a separator 2004. The oil 2002 can be sold, and any produced water that cannot be reused may be disposed of by pumping into a saltwater disposal well (SWD) 2000. The SWD directs the produced/injected water 2001 underground in typically non-hydrocarbon bearing zones deemed disposal zones 2007. Steel casing 2008 and cement 2009 can be designed to force injection into the disposal zone, but the corrosive nature of produced water 2001 can cause these safeguards to degrade and fail over time. After a period of time, the pressure in these disposal zones can rise due to the significant amount of water injected filling the available porosity, or storage capacity, of these zones. Pressured up injection zones may lead to underground fracturing 2006, which may cause undesirable contamination of adjacent zones. The adjacent zones may be freshwater zones 2011 or hydrocarbon bearing zones 2012. The increase of pressure due to water disposal has been linked to earthquakes and induced seismicity in previously seismically inactive areas such as West Texas and Oklahoma.

Produced water may have high sodium content, high Ca²⁺ and Mg²⁺ hardness, and may also contain ions like iron that can precipitate and interfere with hydraulic fracturing fluids and the reservoir they contact. At even moderately high pH values, precipitates of the cations may form. Produced water may also contain aqueous hydrogen sulfide (H₂S), a dangerous substance when released to the gaseous state, and bacteria that continually produce more hydrogen sulfide. If untreated produced water was to be used in a hydraulic fracturing treatment, the chemicals added in a hydraulic fracturing treatment may react with undesirable ions or the ions may mix with an incompatible water in the formation post fracturing to form solid precipitates, clogging the hydrocarbon source reservoir and reducing the productivity of the well being hydraulically fractured. Hydrogen sulfide can potentially be released on surface by agitation during hydraulic fracturing process, creating a dangerous working environment. Thus, produced water in its untreated form may not be suitable for reuse as hydraulic fracturing fluid due to both safety and incompatibility concerns.

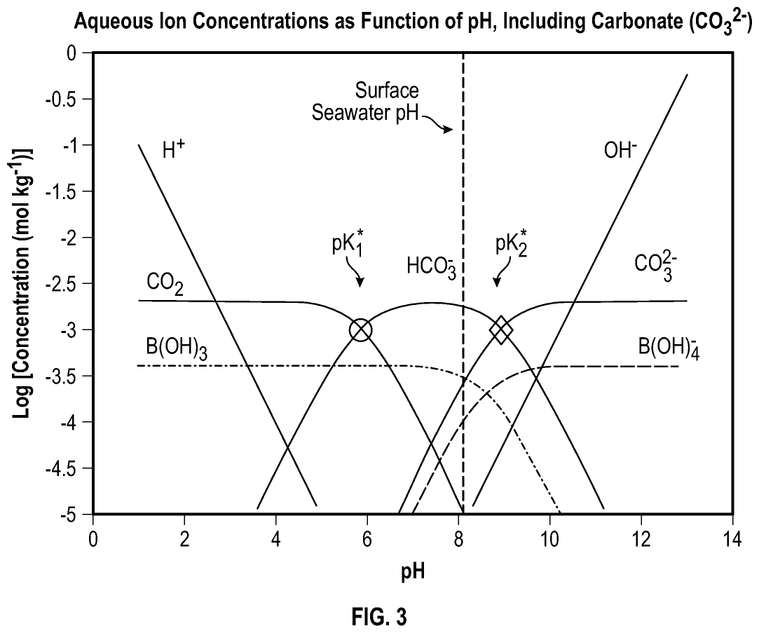

Modern water treatment techniques may use a variety of treatment methods to remove iron, bacteria, and H₂S. However, it may be difficult and expensive to remove the calcium and magnesium ions because high pH values may be necessary for their removal. To raise the pH of a fluid, bases such as NaOH may be added. However, it may be expensive to buy the amounts of NaOH necessary to raise the pH and remove the cations via precipitation reactions. Calcium may be precipitated from water at higher pH values by reacting with the carbonate ion (CO₃²⁻) to form calcium carbonate (CaCO₃) via Reaction 1 (FIG. 4). The change in concentration of the various forms taken by dissolved CO₂ as a function of pH value is shown in FIG. 3. Additional CO₂ may need to be added to the water above what may be obtained from the atmosphere to realize the equilibrium level of carbonate ion necessary for a satisfactory rate of reaction with the calcium ions. At high pH values, the dissolved CO₂ transitions to the carbonate ion, enhancing the reaction kinetics of calcium precipitation.

Despite their undesirability and possible reaction with downhole waters, sodium, calcium, and magnesium commonly remain in the produced water post treatment in current hydraulic fracturing water recycling processes and may be pumped downhole during hydraulic fracturing. At a very high pH values, e.g., in the 9.5-11 range, Mg²⁺ can react with NaOH to form magnesium hydroxide (Mg(OH)₂) via Reaction 2 (FIG. 4). While this reaction does not sequester the carbon from CO₂, it does bring the water one step closer to fresh water with usability beyond hydraulic fracturing.

Sodium carbonate (Na₂CO₃) may also be generated via Reaction 3 (FIG. 3) from the combination of NaOH and CO₂. Sodium carbonate may then be useful as its own product or be used to convert CaCl₂) to CaCO₃ via Reaction 4 (FIG. 4).

To make produced water more usable for agricultural, industrial, or residential use, the calcium and magnesium may need to be removed, and the amount of sodium may need to be significantly reduced. A process that could economically remove these ions would bring the massive amount of produced water that currently lacks application one step closer to agricultural or industrial use. An additional barrier to sodium removal from produced waters is that there may need to be a local use for the sodium as it is a low value product that may be uneconomic to transport long distances to market. A match for the removed sodium to the sodium addition necessary in the brine electrolysis processes may solve this issue. With the location of the produced water in desolate areas such as West Texas, entirely new areas of the country may become farmable with an economic process to clean the produced water of unwanted ions.

Carbon dioxide (CO₂) can be removed from the atmosphere using a variety of methods that fall under two main categories: pre combustion and post combustion. Pre combustion carbon capture implies separating the gaseous CO₂ from a more dilute gas stream, such as air, using processes such as direct air capture. Pre combustion processes may be energy intensive due to the dilute nature of CO₂ in air (˜0.04% of total air mix). Post combustion CO₂ capture focuses on separating the CO₂ from an exhaust stream resulting from the combustion of a fossil fuel. A common shared hurdle for post combustion CO₂ capture is that CO₂ resulting from air combustion is intermingled with the highly abundant nitrogen molecule, making it hard to isolate because nitrogen comprises approximately 78% of air. A second hurdle is that with air molecules being spaced relatively far apart, a liquid medium interreacting with the CO₂ is desirable to achieve high rates of reaction for economic processes.

CO₂ mineralization is a post combustion carbon capture technique in which the CO₂ is converted to a solid, stable form via interaction with a reactive liquid medium. Aqueous CO₂ is not highly reactive with common cations at acidic or neutral pH values. However, at basic pH values CO₂ is oxidized first to bicarbonate HCO₃⁻ and carbonate CO₃²⁻. Carbonate's dual negative charge is an excellent match for common divalent cations such as Mg²⁺ and Ca²⁺ (such as those commonly found in briny water, such as oilfield produced water and/or seawater) because the positive and negative charges bond to form stable ionic compounds.

Current CO₂ mineralization techniques may not be economically attractive. Input costs of current processes may be excessively high due to the need to purchase products containing the reactive cations to bind the CO₂ or the product necessary to raise to pH to accelerate the rate of reaction. The revenues of current processes may be depressed due to creating low value products far away from their end use markets, making achieving profitability difficult. To have an economically attractive mineralization process, the mineralization must be coupled with the manufacture of industrial products of value, ideally near the end market to capture previous transportation costs and markup. For a green process, the CO₂ emissions used to power said industrial process may be captured as part of the products of that process with carbon converted to a stable form, ensuring that energy and value were created without creating excess emissions.

The Shields process, described in greater detail below is an integrated water treatment process that removes the Ca²⁺ and Mg²⁺ hardness from brine water using CO₂ emissions from fossil fuel combustion combined with sodium hydroxide produced via the electrolysis of brine. The energy from combustion of fossil fuels may be converted to electricity, for example by using a motor-generator set (“genset”), generator, turbine, or similar, and used to in the electrolysis of brine. The CO₂ emissions may be captured and stored in a solid form as a carbonate of a divalent cation such as Ca²⁺ or Mg²⁺. The inputs to the process may be produced water containing calcium and/or magnesium ions, fresh water, and the products of hydrocarbon combustion via a generator, i.e., CO₂ and electricity. The final outputs may vary depending on application and local market pricing of products, but in all embodiments the CO₂ generated by hydrocarbon combustion may be sequestered by reaction under basic conditions with a combination of NaOH, Ca²⁺ or Mg²⁺.

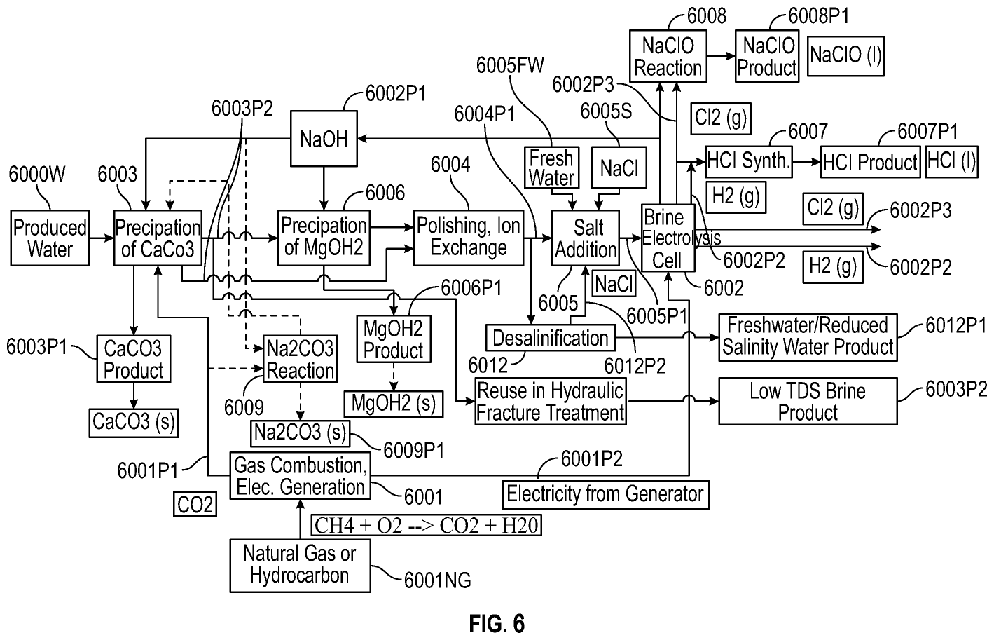

FIG. 6 provides an illustrated visualization of the Shields process. A feature of the Shields processes is a water treatment reaction set wherein the conditioning of the input water using NaOH generated by a brine electrolysis cell may be functionally used to lower the total dissolved solids of said water with respect to non-sodium chloride ions in preparation for use in the same electrolysis cell. The removal of undesirable ions from the starting water may be necessary to prevent fouling of the electrolysis cell components. In cases with significant amounts of dissolved solids in the water other than the NaCl, the electrolysis cell may fail or lose efficiency due to degradation of the cathode, anode, and/or cell membrane. An example of the input water requirements for a brine electrolysis cell is shown in FIG. 5. FIG. 4 links reactor processes of FIG. 6 to the reactions outlined in the table.

FIG. 6 starts with the inputs to the integrated water treatment and carbon sequestration process: (1) produced water 6000W, which may also be seawater or similar brine where there may be a material amounts of Ca²⁺ ion and/or Mg²⁺ ion, and may contain the presence of Na and Cl⁻ ions, and (2) natural gas 6001NG or any other combustible hydrocarbon that yields at least CO₂ and H₂O as the products of combustion with pure oxygen or the oxygen contained in air. In reactor process 6001, the natural gas is ignited in the presence of oxygen to yield the product stream 6001P1 primarily comprised of CO₂, H₂O, and molecules in air that pass through the combustion process without reacting such as Nitrogen (N₂), and energy 6001P2. The energy from the combustion may be converted in a generator, turbine, or similar to yield energy 6001P2 in the form of electricity. The electricity 6001P2 may then be used to drive one or a series of electrolysis cell reactions 6002. The gaseous products of the brine electrolysis reaction process 6002, hydrogen (H₂) 6002P2 and chlorine (Cl₂) 6002P3 may be used as products in pure gas streams. Alternatively, they may be used as reactants in HCl synthesis reactor process 6007 and synthesized to form hydrochloric acid (HCl) 6007P1. Another product of the electrolysis cell may be sodium hydroxide (NaOH) 6002P1. In some embodiments, the NaOH stream 6002P1 may be mixed with the Cl₂ stream 6002P3 as reactants in sodium hypochlorite reactor process 6008 to yield product 6008P1 sodium hypochlorite (NaClO).

Produced water 6000W can be mixed with the NaOH 6002P1 in carbonate precipitation reactor process 6003 to increase the pH of the produced water 6000W. The CO₂ stream 6001P1 can be mixed with water in reactor process 6003 to dissolve the CO₂ into the water 6000W. As the CO₂ dissolves, the increased pH of the water shifts the equilibrium concentration of CO₂ to increase the concentration of the carbonate ion CO₃²⁻ as seen in FIG. 3. The precipitation of product CaCO₃ 6003P1 may consume 2 mols of NaOH per mol of Co₃²⁻ precipitated and can act to lower the pH of the aqueous product via Reaction 1. In the presence of Ca²⁺ ion, the carbonate ion readily reacts to form the product CaCO₃ 6003P1, which may precipitate from the aqueous solution in reactor process 6003. CaCO₃ may precipitate in the form of a sludge and require filtering or dewatering using a diatomaceous earth (DE) press or similar to change into a saleable or usable form.

The aqueous stream 6003P2 leaving reactor process 6003 may be split as the total volume of the product stream 6003P2 may not be necessary to generate the required amount of NaOH 6002P1 necessary as an input in 6003. Reactor process 6002 may only need a portion of the total volume of 6003P2 to be treated and used in 6002 to satisfy NaOH requirements for 6003. Aqueous stream 6003P2 may be reused as water for a hydraulic fracture treatment, continue to Mg²⁺ precipitation process 6006, or skip ahead to ion polishing process 6004 for further ion removal. In some embodiments, it may be desirable to use some or all of NaOH stream 6002P1 and CO₂ stream 6001P2 as reactants in reactor process 6009 to form product sodium bicarbonate (Na₂CO₃) 6009P1. One use of 6009P1 may be to react with Ca²⁺ in reactor process 6003 to form CaCO₃ 6003P1 via Reaction 4.

Some or all of aqueous solution 6003P2 that exits reactor process 6003 may enter an ion exchange reactor process 6004 in which the concentrations of undesirable, non-NaCl, trace ions are lowered to levels required for operation of the electrolysis cell outlined in FIG. 5. Additional salt 6005S and fresh water 6005FW may be added to the aqueous solution 6004P1 leaving reactor process 6004 to increase the NaCl concentration in salt addition reaction process 6005 closer to saturation range for sodium chloride in water to enable more efficient electrolysis cell operation. Saturated brine stream 6005P1 is used as the input brine stream for electrolysis in reaction 6002.

The aqueous stream leaving reactor process 6004 may be split for further processing as the total volume of 6004P1 may not be necessary for use in the electrolysis reaction 6002. The remainder volume of 6004P1 may undergo desalination process 6012, producing a reduced salinity stream 6012P1 and concentrated salt stream 6012P2, which may be used to increase salt concentration in reaction process 6005 and reduce the need for salt addition from other sources such as 6005S. Salt is often seen as an undesirable side product to desalination because a use for large volumes of salt may not be readily available in the vicinity of desalination and transport costs are high relative to salt value. The Shields process solves this well-established economic problem with desalination by pairing the waste products and input products of novel, symbiotic reaction mechanisms.

In some cases, there may exist a material amount of Mg²⁺ hardness such that an additional reactor process 6006 is beneficial for dedicated removal of Mg²⁺. Ca²⁺ is more reactive and likely to precipitate from solution than Mg²⁺ at pH's below 10.5. Resultingly, the pH of reactor process 6003 may be controlled to selectively precipitate the Ca²⁺ ions while precipitating relatively few Mg²⁺ ions. This separation of precipitation conditions allows pure products to be obtained in separate reactor processes 6003 and 6006 respectively. Stream 6003P2 may exit reactor process 6003 at a pH below 10.5. NaOH stream 6002P1 may be added to stream 6003P2 in reactor process 6006 to precipitate product Magnesium Hydroxide (Mg(OH)₂) 6006P1.

Described above are various features and embodiments relating to produced water treatment with CO₂ absorption. Such arrangements may be used in a variety of applications and may be adapted to particular implementation conditions without departing from the principles described herein. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A method of water treatment comprising:
obtaining produced water containing Ca²⁺ ions;
combining the produced water with NaOH to increase a pH of the produced water;
combining the produced water with byproducts of hydrocarbon combustion containing CO₂, thereby dissolving the CO₂ in the produced water and increasing a concentration of CO₃²⁻ that combines with the Ca²⁺ to produce CaCO₃;
precipitating the CaCO₃ to produce a CaCO₃ product stream and an aqueous product stream; and
providing at least a portion of the aqueous product stream to an electrolysis cell, wherein the electrolysis cell produces the NaOH that is combined with the produced water.

2. The method of claim 1 wherein the produced water further contains Mg²⁺ ions that combine with the NaOH to produce Mg(OH)₂.

3. The method of claim 2 further comprising controlling the pH of the produced water to selectively precipitate the Ca²⁺ ions while precipitating relatively few Mg²⁺ ions.

4. The method of claim 1 further comprising using at least a portion of the aqueous product stream for hydraulic fracturing of a hydrocarbon bearing formation.

5. The method of claim 1 further comprising:
pretreating the portion of the aqueous product stream provided to the electrolysis cell using an ion exchange process that reduces trace ions other than Na⁺ and Cl⁻ in the aqueous product stream to produce an output stream having acceptable ion concentrations for operation of the electrolysis cell.

6. The method of claim 5 wherein pretreating the portion of the aqueous product stream provided to the electrolysis cell further comprises increasing a NaCl concentration of the output stream prior to providing it as an input stream to the electrolysis cell, thereby improving electrolysis cell efficiency.

7. The method of claim 5 further comprising providing a portion of the output stream not provided as an input stream to the electrolysis cell to a de-salinification process that produces NaCl and a reduced salinity water product.

8. The method of claim 7 further comprising adding NaCl produced by the de-salinification process to the output stream prior to providing it as an input stream to the electrolysis cell, thereby improving electrolysis cell efficiency.

9. The method of claim 1 further comprising combining NaOH produced by the electrolysis cell with a portion of the CO₂ from the byproducts of hydrocarbon combustion to produce Na₂CO₃.

10. The method of claim 9 further comprising combining the Na₂CO₃ with the produced water to enhance production of CaCO₃.

11. The method of claim 1 wherein the electrolysis cell is powered by electricity produced by the energy from the hydrocarbon combustion.

12. The method of claim 1 wherein H₂ gas and Cl₂ gas produced by the electrolysis cell are combined to produce HCl.

13. The method of claim 1 wherein NaOH and Cl₂ produced by the electrolysis cell are provided as inputs to a NaClO reactor to produce NaClO.

14. The method of claim 3 further comprising:
providing at least a portion of the aqueous product stream as an input into a Mg²⁺ precipitation process that further comprises adding NaOH to precipitate Mg(OH)₂ to produce a further aqueous product stream; and
providing at least a portion of the further aqueous product stream to the electrolysis cell.

15. The method of claim 14 further comprising:
pretreating the portion of the further aqueous product stream provided to the electrolysis cell using an ion exchange process that reduces trace ions other than Na⁺ and Cl⁻ in the aqueous product stream to produce an output stream having acceptable ion concentrations for operation of the electrolysis cell.

16. The method of claim 15 wherein pretreating the portion of the aqueous product stream provided to the electrolysis cell further comprises increasing a NaCl concentration of the output stream prior to providing it as an input stream to the electrolysis cell, thereby improving electrolysis cell efficiency.

17. The method of claim 15 further comprising providing a portion of the output stream not provided as an input stream to the electrolysis cell to a de-salinification process that produces NaCl and a reduced salinity water product.

18. The method of claim 17 further comprising adding NaCl produced by the de-salinification process to the output stream prior to providing it as an input stream to the electrolysis cell, thereby improving electrolysis cell efficiency.

19. The method of claim 14 further comprising combining NaOH produced by the electrolysis cell with a portion of the CO₂ from the byproducts of hydrocarbon combustion to produce Na₂CO₃.

20. The method of claim 19 further comprising combining the Na₂CO₃ with the produced water to enhance production of CaCO₃.

21. The method of claim 14 wherein the electrolysis cell is powered by electricity produced by the energy from the hydrocarbon combustion.

22. The method of claim 14 wherein H₂ gas and Cl₂ gas produced by the electrolysis cell are combined to produce HCl.

23. The method of claim 14 wherein NaOH and Cl₂ produced by the electrolysis cell are provided as inputs to a NaClO reactor to produce NaClO.

24. The method of claim 1 wherein the produced water is selected from the group consisting of water produced from a hydrocarbon well and seawater.
